(19) United States
(12) Patent Application Publication
(10) Pub. No.: US 2015/0348166 A1
(43) Pub. Date: Dec. 3, 2015

(54) SYSTEM AND METHOD FOR PROVIDING ENHANCED FINANCIAL SERVICES BASED ON SOCIAL SIGNALS

(71) Applicant: Capital One Financial Corporation, McLean, VA (US)

(72) Inventors: Dwij TRIVEDI, North Bethesda, MD (US); Charles D. WOOD, Reston, VA (US); Michael KIERNAN, Fairfax, VA (US); Anant SAJNANI, McLean, VA (US); Gabe B. GINDELE, Herndon, VA (US)

(21) Appl. No.: 14/722,259

(22) Filed: May 27, 2015

Related U.S. Application Data
(60) Provisional application No. 62/003,171, filed on May 27, 2014.

(51) Int. Cl. G06Q 30/06; G06F 9/54

(52) U.S. Cl. CPC G06Q 30/0631; G06F 9/541

(57) ABSTRACT

A system and method includes a data store that stores information about a plurality of product offerings, a communication interface that receives, via a network, social signals information, a social signals processor coupled to an application programming interface that enables transmission of the social signals information, wherein the social signals processor detects a change in profile information, geo-social information, status information, or social media preference, and a product offering processor that determines a product offering from among the plurality of product offerings based on the detected change in profile information, geo-social information, status information, or social media preference.

### CROSS-REFERENCE TO RELATED APPLICATIONS

This application contains subject matter related to and claims the benefit of U.S. Provisional Patent Application No. 62/003,171, filed on May 27, 2015, the entire contents of which is incorporated herein by reference.

The present application contains subject matter related to U.S. patent application Ser. No. 14/031,263 filed on Sep. 19, 2013 and entitled “System and Method for Determining Social Statements,” U.S. patent application Ser. No. 15/566,862 filed on Dec. 11, 2014 and entitled “System and Method for Financial Transfers from a Financial Account Using Social Media,” and U.S. Provisional Patent Application No. 61/737,399 entitled “System and Method for Synching a Financial Account with a Social Network Account,” the entire contents of each of which is incorporated herein by reference.

### FIELD OF THE DISCLOSURE

The present disclosure relates to systems and methods for providing an interface that enables provision of enhanced financial products to an individual based on social signals.

### BACKGROUND OF THE DISCLOSURE

A strong link exists between a life event and triggering of a financial need. Being able to identify relevant events in a person's life early can help entities market relevant products and offer the best terms to an individual based on the life event. Many entities do not have a good way of detecting when potential and current customers experience a major life event. Financial institutions have access to the financial data and transaction data of their customers, which may not accurately reflect major events in a customer's life until after they occur. At the same time, people are increasingly giving signals and sharing actual life events on social media.

These and other drawbacks exist.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts a schematic diagram of a system for providing enhanced financial products to an individual based on social signals, according to an example embodiment of the disclosure;

FIG. 2 depicts a schematic diagram of a system for providing enhanced financial products to an individual based on social signals, according to an example embodiment of the disclosure; and

FIG. 3 depicts a schematic diagram of a method for providing enhanced financial products to an individual based on social signals, according to an example embodiment of the disclosure.

### DETAILED DESCRIPTION OF THE EMBODIMENTS

The following description is intended to convey a thorough understanding of the embodiments described by providing a number of specific example embodiments and details involving systems and methods for providing products and services to an individual based on social signals. As used herein, the term “social signals” may refer to social data associated with and/or extracted and/or received from an individual's social networking profiles. Social data may include likes, pins & preferences, profile information, social connections (e.g., friends, followers, connections) geo-social information, and major life events. It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in any number of alternative embodiments, depending on specific design and other needs. A financial institution and system supporting a financial institution are used as examples for the disclosure. The disclosure is not intended to be limited to financial institutions only.

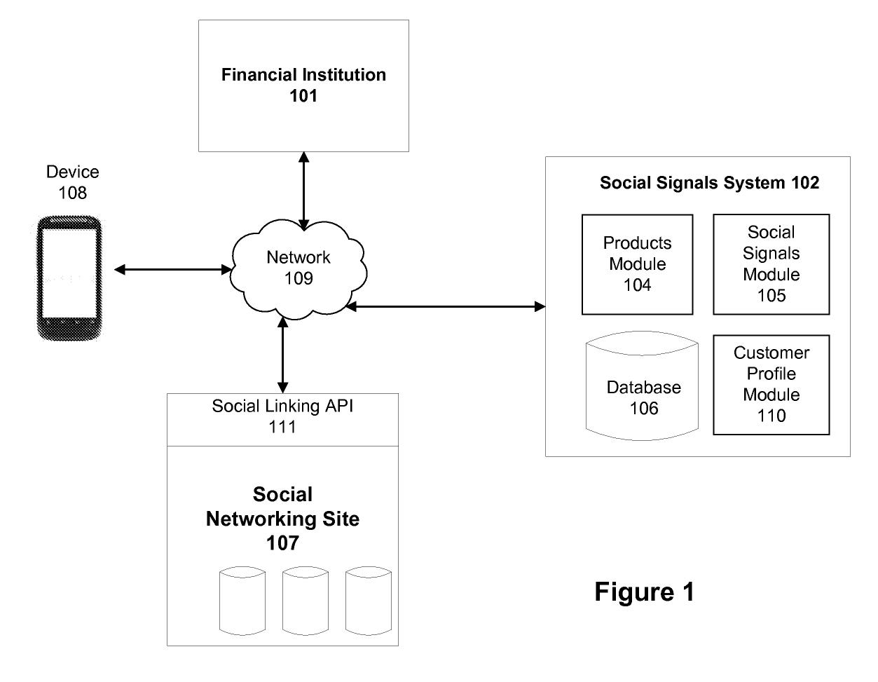

FIG. 1 depicts an example embodiment of a system for providing products and services to an individual based on social signals according to various embodiments of the disclosure. The system may include various network-enabled computer systems, including, as depicted in FIG. 1 for example, a financial institution 101; a social signals system 102 comprising a products module 104, a social signals module 105, a customer profile module 110, and a database 106; a social networking site 107, and a social linking application programming interface (API) 111, which may be included as separate processors or combined into a single processor or device having the multiple processors. As used herein, the term “module” may be understood to refer to computer executable software, firmware, hardware, or various combinations thereof. It is noted that the modules are example. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one device and added to another device, or may be included in both devices.

In the example embodiment shown in FIG. 1, social signals system 102 is separate from financial institution 101 and social networking site 107. System 102 also may be integrated into financial institution 101. System 102 also may be integrated into social networking site 107. As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The network-enabled computer systems may execute one or more software applications to, for example, receive data as input from an entity accessing the network-enabled computer system, process received data, transmit data over a network, and receive data over a network.

The components depicted in FIG. 1 may store information in various electronic storage media, such as, for example, database 106. Electronic information, files, and documents may be stored in various ways, including, for example, a flat file, indexed file, hierarchical database, relational database, such as a database created and maintained with software from, for example, Oracle® Corporation, Microsoft® Excel file, Microsoft® Access file, or any other storage mechanism.

The components depicted in FIG. 1 may be coupled via one or more networks, such as, for example, network 109. Network 109 may be one or more of a wireless network, a wired network or any combination of wireless network and wired network. For example, network 109 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11b, 802.15.1, 802.11n and 802.11g or any other wired or wireless network for transmitting and receiving a data signal.

In addition, network 109 may include, without limitation, telephone lines, fiber optics, IEEE Ethernet 902.3, a wide area network (“WAN”), a local area network (“LAN”), or a global network such as the Internet. Also network 109 may support an Internet network, a wireless communication network, a cellular network, or the like, or any combination thereof. Network 109 may further include one network, or any number of the example types of networks mentioned above, operating as a stand-alone network or in cooperation with each other. Network 109 may utilize one or more protocols of one or more network elements to which they are communicatively coupled. Network 109 may translate to or from other protocols to one or more protocols of network devices. Although network 109 is depicted as a single network, it should be appreciated that according to one or more embodiments, network 109 may comprise a plurality of interconnected networks, such as, for example, the Internet, a service provider's network, a cable television network, corporate networks, and home networks.

In various example embodiments, an account holder may be any individual or entity that desires to conduct a financial transaction using one or more accounts held at one or more financial institutions. Also, an account holder may be a computer system associated with or operated by such an individual or entity. An account may include any place, location, object, entity, or other mechanism for holding money or performing transactions in any form, including, without limitation, electronic form. An account may be, for example, a credit card account, a prepaid card account, stored value card account, debit card account, check card account, payroll card account, gift card account, prepaid credit card account, charge card account, checking account, rewards account, line of credit account, credit account, mobile device account, or mobile commerce account. A financial institution may be, for example, a bank, other type of financial institution, including a credit card provider, for example, or any other entity that offers accounts to customers. An account may or may not have an associated card, such as, for example, a credit card for a credit account or a debit card for a debit account. The account card may be associated or affiliated with one or more social networking sites, such as a co-branded credit card.

As used herein, social networking site 107 may include a website and/or mobile applicationthat allows a user to create an account and provide user-specific information, including interests, and network with other users based on social connections. Examples of social networking sites may include, without limitation, Facebook, MySpace, Google+, LinkedIn, Twitter, Pintrest, Yelp, Foursquare, or the like. Social networking site 107 may maintain accounts holding social media data for an account holder, such as, for example, user name, user phone number, user address, user email address, user occupation, and/or user location information.

Customer profile module 110 may link social signals system 102 with an account holder's social networking profile at social networking site 107. Linking the social networking profile with the customer profile module may include receiving, at the social networking site, account details of a financial account held by the account holder at financial institution 101 and/or receiving, at the customer profile module 110, account details of the account holder's account held at a social networking site 107. The linking process may include an opt-in process. For example, the account holder may use device 108 and/or a similar device to opt-in and allow the customer profile module 110 to access data held at social networking site 107 associated with the account holder. The account holder may opt-in using one or more applications on device 108. The account holder may provide a username and/or password for his account at social networking site 107. The applications may be part of a mobile banking application provided by financial institution 101. The account holder also may opt-in and allow social networking site 107 to provide data to the social signal system 102. Device 108 may be any computer device, or communications device including, e.g., a server, a network appliance, a personal computer (PC), a workstation, a mobile device, a phone, a handheld PC, a personal digital assistant (PDA), a thin client, a tablet computer, a smartphone, a fat client, an Internet browser, or other device. Non-limiting examples of a smartphone include an iPhone or an Android-enabled phone. A mobile device also may be a tablet computer. Non-limiting examples of a tablet computer include an iPad, Kindle Fire, Playbook, Touchpad, and the like.

Data provided by the social media system may include, for example, location data and/or social media preference data, including privacy preferences associated with the social media account. Moreover, the linking process may occur through a social linking application programming interface (“API”) 111.

Social linking API 111 may allow certain data to be transmitted through the API so that social networking site 107 may communicate with social signal system 102 and/or financial institution 101. Social linking API 111 may prevent data other than approved data to be transmitted through the API. For example, the social linking API 111 may only support user name, user e-mail address, user identification information, and/or user location information to be transmitted from the social networking site 107 to the social signal system 102. Also, social linking API 111 may allow account holder relationship data to be transmitted to social signals system 102 if an account holder opts-in to allow relationship data to be provided to the social signals system 102. For example, relationship data may include data indicative of a group of people, such as family, close friends, and/or colleagues. In various embodiments, social linking API 111 may be part of social signals system 102 and/or financial institution 101.

By linking social networking site 107 with social signals system 102, an account holder authorizes the social media system to transmit certain subscriber data, such as subscriber location data, from the social media system to the account provider system. Moreover, by linking the social media system with the account provider system, a social media subscriber authorizes the account provider system to transmit account holder data, such as account data, including, for example, an account number and a routing number; a transfer amount; and/or recipient data, including, for example, recipient name, recipient email address, recipient phone number, and/or recipient social media identification data.

Social linking API 111 may provide encryption and filtering functionality to prevent, for example, identity theft and fraudulent transactions. For example, the social linking API 111 may filter out personally identifying information that is unnecessary to carry out the claimed methods, such as, social security numbers. A social inking API 111 may also encrypt, for example, account and routing numbers to ensure that any passing account identifying data is secure during transmission and storage.

Customer profile module 110 may link one or more financial accounts for the customer with his social networking profile. This information may be stored in database 106. Once customer profile module 110 has accessed the social network profile of the customer, social signals module 105 may receive one or more social signals from social networking site 107. Social signals may comprise four categories of information: (1) Likes, Pins & Preferences; (2) Profile information; (3) Geo-Social information; (4) Social Connections; and (5) Event information. Social signals module 105 may periodically or regularly receive this information from social networking site 107 using, for example, screen scraping technology.

Likes, Pins & preferences data may include, for example, data from the account holder's social networking profile indicating the account holder's approval of something. For example, an account holder, while accessing his social media profile at social networking site 107, may “like” a friend's posted photos, a business's social media page, posted articles, comments and posts from other users, status updates, and other content and media posted at social networking site 107. Each time the account holder “likes” posts or content at social networking site 107, a social signal may be generated and sent to social signals module 105. The social signal may include descriptive information or data relating to whatever it is that the account holder “liked.” In various embodiments, when the account holder comments on another user's posting, a social signal may be generated and set to social signals module 105. The social signal may include the content of the account holder's comment, as well as the content of whatever the account holder was commenting on. Social linking API 111 may monitor the account holder's social networking profile to detect new “likes”, preferences, and/or comments from the account holder, and provide this information to social signals module 105. Social signals module 105 may provide the signal to products module 104.

Profile information data may include demographic data from the account holder's social networking profile. Profile information may include the account holder's date of birth, hometown, current occupation, employment history, current location, educational history, relationship status, favorite quotes, social relationships (friends, family members, co-workers), information about different groups that the account holder is a part of, favorite TV shows, movies, books, games, sport's teams, and other data that the comprises the account holder's social networking profile at social networking site 107. Social linking API 111 may monitor the account holder's social networking profile to detect changes and updates to the account holder's profile information, and provide this to social signals module 105. Social signals module 105 may provide the signals to products module 104.

Geo-social signals may include location-based information provided by the account holder on their social networking profile. The account holder may “check-in” at a location on social networking site 107, indicating that the account holder is currently or was recently at that location. The location-based information may include GPS coordinates corresponding to the account holder's location. The geo-social signals may include the name of the location (e.g., a restaurant, concert venue, tourist attraction, club, etc.), a physical address, and other descriptive information. The geo-social signals may include names and profile information for other users who were with the account holder at the location. Social linking API 111 may monitor the account holder's social networking profile to detect new geo-social information from the account holder, and provide this to social signals module 105.

Event information may include, for example, major life events posted by the account holder to their social networking profile. Major life events may include a new job, an engagement, college graduation, a move to a new city, birth of a child, a marriage, a new relationship, a pay raise, or other events. Event information may include “status” updates, posts and/or timeline information provided by the account holder on their social networking profile. Social linking API 111 may monitor the account holder's social networking profile to detect new events and status updates from the account holder, and provide this to social signals module 105 and/or products module 104. Social signals module 105 may be configured to analyze events and status updates using one or more neural networks capable of machine learning and pattern recognition. Social signals module 105 may scan posts, status updates, and other event data to recognize an event. For example, and account holder may add a post to his social networking account stating “We are so excited to welcome baby Jane to our family, born on Mar. 1, 2014.” The social signals module 105 may use one or more neural networks to analyze this post and determine that the account holder had a new baby (Jane) on Mar. 1, 2014. The account holder may add a post to his social networking account stating “Can I borrow $50 from someone.” Social signals module 105 may use the one or more neural networks to analyze this post and determine that the account holder needs money ($50).

Products module 104 may generate one or more financial product offers for the account holder based on the social signals. Products module 104 may generate one or more financial products within a certain predetermined time after receiving social signals. Products module 104 may generate a risk score based on the social signals. A financial product may refer to any product or service offered by financial institution 101, such as a loan, a credit card, an insurance policy, a mortgage, a checking account, a debit account, a prepaid card, a rewards program. line of credit offer, a rewards program offer, a loan offer, a pre-approved line of credit, and the like. The products may be specifically tailored to the account holder for based on the social signals. The products may be provided to the account holder for reviewing on device 108 within a certain predetermined time of when they are generated. The products may be provided to the account holder in real-time.

In one example, products module 104 may receive social signals indicating a major life event for the account holder. The major life event may be a move to a new city. Products module 104 may generate one or more home loan offers for the account holder, based on the social signal, to encourage the account holder to purchase a home in the new location. The terms of the home loan may be further based on received social signals comprising Profile information, such as the account holder's age, relationship status, educational background, and/or current employer. The financial product may be an offer of a line of credit to encourage the account holder to purchase new furniture, clothes, electronics, or other items for a new home or apartment. For example, if the account holder's Profile information (from the social signals) indicates that the account holder is a single 25 year-old recent college graduate who has worked for less than a year at an entry-level position with an insurance company and has just moved to a new apartment, products module 104 may generate a line of credit offer with no enrollment fee, and a 5% APR. If the account holder's Profile information indicates that the account holder is a 40 year-old married mid-level executive at the same insurance company, products module 104 may generate a line of credit offer with no enrollment fee and a 2% APR. The credit offer may be provided to device 108, or on social networking site 107 at the account holder's social networking profile.

In various embodiments, an account holder's social signals may include a status update indicating that the account holder's car has broken down and/or is in the shop. The social signal may include a status update indicating the account holder is looking for a new car. Products module 104 may generate one or more financial products based on this information. The financial products may include a car loan, or an offer for a line of credit that includes an initial 10,000 rewards points that can be redeemed with a local car rental agency.

In various embodiments, an account holder's social signals may include likes & preferences data indicating the account holder has “liked” a certain brand of clothing. Products module 104 may generate one or more financial products that include rewards programs that provide discounts on that brand of clothing and/or at a retailer that offers that brand of clothing (or similar brands of clothing). Products module 104 may provide the financial products to device 108 for review by the account holder. The products may include an offer to expand a line of credit associated with a pre-existing financial account of the account holder. The products may include an offer to upgrade the account or change terms (such as the APR, annual fee, etc.) in exchange for some action by the account holder.

Products module 104 may weigh social signals equally and/or according to various differing weights. In various embodiments, products module 104 may give Event signals more weight than Likes & preferences signals. Products module 104 may give Event signals equal weight with Profile signals, but more weight than geo-location signals. Products module 104 may generate a risk score for the account holder based on the received social signals. The risk score may be based on the various weights attributed to the various social signals. The risk score may be used to generate and/or identify the one or more financial products. Products module 104 may receive financial data relating to the account holder from financial institution 101 and/or from a third party source (such as a credit bureau). The financial data may include a credit score. Products module 104 may generate a financial product based at least in part on the risk score and the credit score. For example, products module 104 may receive social signals indicating that an account holder just obtained a residency at a prestigious hospital. The account holder may have just graduated from medical school with significant debt (and social signals module 105 may receive one or more social signals indicating this). The account holder may have a low credit score. Products module 104 may generate a risk score for the account holder that is higher than the credit score, based at least in part on the social signal indicating that the account holder has a new job that is likely to be stable and high paying. Products module 104 may generate one or more financial products with more favorable terms based on the risk score and not the credit score. Products module 104 may give greater weight to the risk score than the credit score.

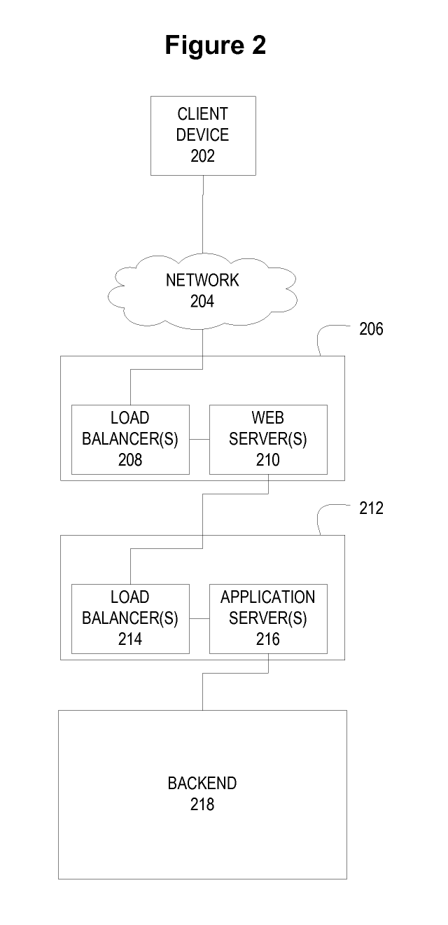

FIG. 2 depicts an example system 200 for providing enhanced financial products to an individual based on social signals. As shown in FIG. 2, system 200 may include a client device 202, a network 204, a front-end controlled domain 206, a back-end controlled domain 212, and a backend 218. Front-end controlled domain 206 may include one or more load balancers 208 and one or more web servers 210. Back-end controlled domain 212 may include one or more load balancers 214 and one or more application servers 216.

Client device 202 may be a network-enabled computer. Client device 202 may be similar to buyer device 102a and/or seller device 102b. Client device 202 may be configured to execute one or more applications. As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 200 may execute one or more software applications to enable, for example, network communications.

Client device 202 also may be a mobile device: For example, a mobile device may include an iPhone, iPod, iPad from Apple® or any other mobile device running Apple's iOS operating system, any device running Google's Android® operating system, including for example, Google's wearable device, Google Glass, any device running Microsoft's Windows® Mobile operating system, and/or any other smartphone or like wearable mobile device.

Network 204 may be one or more of a wireless network, a wired network, or any combination of a wireless network and a wired network. For example, network 204 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 204 may include, without limitation, telephone lines, fiber optics, IEEE Ethernet 902.3, a wide area network (WAN), a local area network (LAN) or a global network such as the Internet. Also, network 110 may support an Internet network, a wireless communication network, a cellular network, or the like, or any combination thereof. Network 204 may further include one network, or any number of example types of networks mentioned above, operating as a stand-alone network or in cooperation with each other. Network 204 may utilize one or more protocols of one or more network elements to which they are communicatively couples. Network 204 may translate to or from other protocols to one or more protocols of network devices. Although network 204 is depicted as a single network, it should be appreciated that according to one or more embodiments, network 204 may comprise a plurality of interconnected networks, such as, for example, the Internet, a service provider's network, a cable television network, corporate networks, and home networks.

Front-end controlled domain 206 may be implemented to provide security for backend 218. Load balancer(s) 208 may distribute workloads across multiple computing resources, such as, for example computers, a computer cluster, network links, central processing units or disk drives. In various embodiments, load balancer(s) 208 may distribute workloads across, for example, web server(S) 210 and/or backend 218 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 208 and 214 may include software that monitoring the port where external clients, such as, for example, client device 202, connect to access various services of a financial institution or third party (such as system 100 shown in FIG. 1), for example. Load balancer(s) 208 may forward requests to one of the application servers 216 and/or backend 218 servers, which may then reply to load balancer 208. This may allow load balancer(s) 208 to reply to client device 202 without client device 202 ever knowing about the internal separation of functions. It also may prevent client devices from contacting backend servers directly, which may have security benefits by hiding the structure of the internal network and preventing attacks on backend 218 or unrelated services running on other ports, for example.

A variety of scheduling algorithms may be used by load balancer(s) 208 to determine which backend server to send a request to. Simple algorithms may include, for example, random choice or round robin. Load balancers 208 also may account for additional factors, such as a server's reported load, recent response times, up/down status (determined by a monitoring poll of some kind), number of active connections, geographic location, capabilities, or how much traffic it has recently been assigned.

Load balancers 208 may be implemented in hardware and/or software. Load balancer(s) 208 may implement numerous features, including, without limitation: asymmetric loading; Priority activation: SSL Offload and Acceleration; Distributed Denial of Service (DDoS) attack protection; HTTP compression; TCP offloading; TCP buffering; direct server return; health checking; HTTP caching; content filtering; HTTP security; priority queuing; rate shaping; content-aware switching; client authentication; programmatic traffic manipulation; firewall; intrusion prevention systems.

Web server(s) 210 may include hardware (e.g., one or more computers) and/or software (e.g., one or more applications) that deliver web content that can be accessed by, for example a client device (e.g., client device 202) through a network (e.g., network 204), such as the Internet. In various examples, web servers, may deliver web pages, relating to, for example, online banking applications and the like, to clients (e.g., client device 202). Web server(s) 210 may use, for example, a hypertext transfer protocol (HTTP or sHTTP) to communicate with client device 202. The web pages delivered to client device may include, for example, HTML documents, which may include images, style sheets and scripts in addition to text content.

A user agent, such as, for example, a web browser, web crawler, or native mobile application, may initiate communication by making a request for a specific resource using HTTP and web server 210 may respond with the content of that resource or an error message if unable to do so. The resource may be, for example a file on stored on backend 218. Web server(s) 210 also may enable or facilitate receiving content from client device 202 so client device 202 may be able to, for example, submit web forms, including uploading of files.

Web server(s) also may support server-side scripting using, for example, Active Server Pages (ASP), PHP, or other scripting languages. Accordingly, the behavior of web server(s) 210 can be scripted in separate files, while the actual server software remains unchanged.

Load balancers 214 may be similar to load balancers 208 as described above.

Application server(s) 216 may include hardware and/or software that is dedicated to the efficient execution of procedures (e.g., programs, routines, scripts) for supporting its applied applications. Application server(s) 216 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Also, application server(s) 216 may act as a set of components accessible to, for example, a financial institution or other entity implementing system 200 and/or system 100, through an API defined by the platform itself. For Web applications, these components may be performed in, for example, the same running environment as web server(s) 210, and application servers 216 may support the construction of dynamic pages. Application server(s) 216 also may implement services, such as, for example, clustering, fail-over, and load-balancing. In various embodiments, where application server(s) 216 are Java application servers, the web server(s) 210 may behaves like an extended virtual machine for running applications, transparently handling connections to databases associated with backend 218 on one side, and, connections to the Web client (e.g., client device 202) on the other.

Backend 218 may include hardware and/or software that enables the backend services of, for example, a financial institution, social networking site or other entity that maintains a distributed system similar to system 200 and/or system 100. For example, backend 218 may include, a system of record, online banking applications, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, a social signals system (e.g., system 102 shown in FIG. 1) and the like. Backend 218 may be associated with various databases, including account databases that maintain, for example, customer account information, product databases that maintain information about products and services available to customers, content databases that store content associated with, for example, a financial institution, and the like. Backend 218 also may be associated with one or more servers that enable the various services provided by system 200. Backend 218 may be associated with one or more servers that enable the various services provided by system 100.

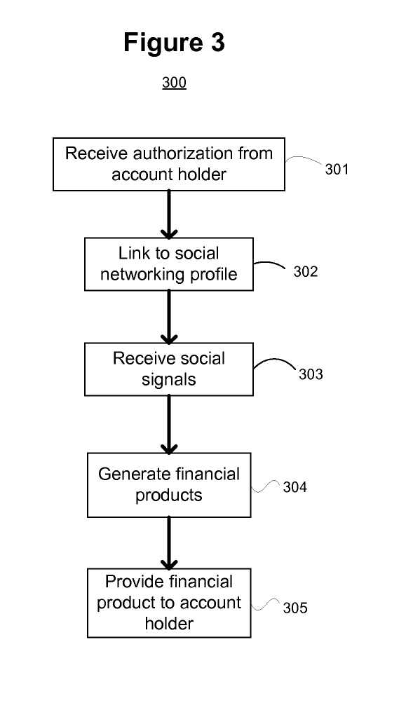

FIG. 3 is a flow chart illustrating a method for providing enhanced financial products to an individual based on social signals. The method 300 shown in FIG. 3 can be executed or otherwise performed by one or more combinations of various systems. The method 300 as described below may be carried out by the system for providing enhanced financial products to an individual based on social signals, as shown in FIG. 1, by way of example, and various elements of that system are referenced in explaining the method of FIG. 3. Each block shown in FIG. 3 represents one or more processes, methods, or subroutines in the example method 300. Referring to FIG. 3, the example method 300 may begin at block 301.

At block 301, authorization may be received from an account holder to link a social media account to the social signals system. For example, an account holder may, using a social linking API authorize a social signals system associated with the account holder's bank to link the account holder's Facebook page. The authorization may be in the form of a username and password for the social media account. The social media account may be maintained by a social networking site. The user may enter the authorization information into an application on a device. The application may be part of a mobile banking application provided by the account holder's financial institution. Method 300 may proceed to block 302.

At block 302, a social media account may be linked to the social signals system (such as system 102 in FIG. 1), based on the received authorization data. A linking may be facilitated by a social linking API. The social linking API may be provided by the social networking site that maintains the social media account. The social media account may be associated with an account holder who also has an account with a financial institution. The social signals system may link the social media account with the financial account in a database. The social signals system may be maintained by the financial institution or financial services provider.

A social linking API may allow certain data to be transmitted through the API so that a social media system may communicate with a social signals system. The social inking API may format data to be transmitted between a social media system and the social signals system. The social linking API also may prevent data other than approved data to be transmitted through the API. For example, the API may only support the account holder's name, e-mail address, identification information, phone number, and location information to be transmitted from the social media system to the social signals system. Also, the social linking API may allow account holder's relationship data to be transmitted to the social signals system if a social media subscriber opts-in to allow relationship data to be provided to the account provider system.

A social linking API may provide encryption and filtering functionality to prevent, for example, identity theft and fraudulent transactions. For example, the social linking API may filter out personally identifying information that is unnecessary to carry out the claimed methods, such as, social security numbers. A social inking API may also encrypt, for example, account and routing numbers to ensure that any passing account identifying data is secure during transmission and storage. Method 300 may proceed to block 303.

At block 303, social signals may be received from the social media account. The social signals may be received by a communication interface associated with the social signals system. The social signals may include, for example, likes & preferences data, profile data, geo-social data, and/or event data from the social media account for the account holder. Likes & preferences data may include data from the account holder's social networking profile indicating the account holder's approval of posted content. For example, an account holder, while accessing his social media profile at social networking site 107, may “like” pictures, videos, articles, social media pages, movies, TV shows, bands, brands, restaurants, comments, and other content posted on the social networking site. Profile information may include the account holder's date of birth, hometown, current occupation, employment history, current location, educational history, relationship status, favorite quotes, social relationships (friends, family members, co-workers), information about different groups that the account holder is a part of, favorite TV shows, movies, books, games, sport's teams, and similar data. Geo-social data may include location-based information provided by the account holder on their social networking profile. The account holder may “check-in” at a location on social networking site 107, indicating that the account holder is currently or was recently at that location. Geo-social data may include GPS coordinates corresponding to the account holder's location. Geo-social data may include the name of the location (e.g., a restaurant, concert venue, tourist attraction, club, etc.), a physical address, and other descriptive information. Geo-social data may include names and profile information for other users who were with the account holder at the location. Event data may include major life events and/or status updates from the social media account, including a new job, an engagement, graduation, a move, birth of a child, a marriage, a new relationship, a pay raise, or other events. The account holder's social media profile may be monitored for new or updated social signals, and these may be pushed or transmitted to the social signals system in real-time (i.e., as soon as an account holder updates his status for his social media profile, this event data is provided to the social signals system). Method 300 may proceed to block 304.

At block 304, one or more product offerings may be generated based on the social signals. The financial product may be a credit limit increase program. The product may be targeted to the account holder based on the social signals from the social media account associated with the account holder. In one example, the account holder may currently have a credit account. The social signals system may generate a credit limit increase offer for the account holder, with better products & terms than the current credit account. The offer may be based on received social signals. The social signal may be event data indicating the account holder just got his first job out of college. The social signal may include profile data with the name of the new employer. The social signal may include geo-location data and/or profile data with the location of the new employer and/or the new location where the account holder is going to live. The credit limit increase offer may be based on these signals. If the social signals indicate that the account holder just obtained his MBA and got a job with a large consulting firm (based on status updates and changes to the account holder's social media profile), the credit limit increase offer generated by the social signals system may include a higher line of credit (e.g., an increase from a $10,000 credit limit to a $20,000 credit limit, with no annual fee). If the social signals indicate that the account holder obtained a bachelor's degree and got an entry-level marketing job, the credit limit increase offer may be smaller (e.g., an increase from a $10,000 credit limit to a $12,500 credit limit, with a smaller annual fee).

In various embodiments, social signals system may receive one or more social signals comprising Event data indicating that an account holder just got engaged. The social signals system may generate an offer for a line of credit that includes a miles program that is targeted to the account holder who may want to accrue rewards that can be redeemed for frequent flyer miles in order to fly to different locations for a wedding and/or honeymoon. The offer may be based on profile data and/or geo-location data received by the social signals system. The geo-location data may indicate that the account holder frequently travels to a certain city for business. The offer may include rewards points or programs that can be redeemed at locations in that city.

In various embodiments, social signals system may generate a risk score for the account holder based on the received social signals. The risk score may be used by the financial institution and/or social signals system to generate financial product offers for the account holder in lieu of a bad credit score. The risk score may be based on profile data (e.g., the account holder's current job, how long they have been employed there). The risk score may be based on event data. For example, if the social signals include a new status update indicating that the account holder just obtained a relatively secure job as a tenured professor at a university, the social signals system may lower the risk score of the account holder. A lower risk score may indicate that the account holder is eligible for financial products with better terms (such as pre-approval for certain lines of credit). Social signals system may generate a financial product offer based on the better risk score, even if the account holder has a relatively low credit score. Method 300 may proceed to block 305.

At block 305, the product offer may be provided to the account holder. The offer may be provided to a device associated with the account holder. The account holder may be able to view the offer and its terms using an application on the device. For example, the application may be part of a mobile banking application. The account holder may be able to accept the offer and/or respond to the offer using an interface provided by the application.

It is further noted that the software described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, processors, etc.) separately. The functions described as being performed at various components may be performed at other components, and the various components bay be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A system, comprising:
a data store that stores information about a plurality of product offerings;
a communication interface that receives, via a network, social signals information;
a social signals processor coupled to an application programming interface that enables transmission of the social signals information, wherein the social signals processor detects a change in profile information, geo-social information, status information, or social media preference; and
a product offering processor that determines a product offering from among the plurality of product offerings based on the detected change in profile information, geo-social information, status information, or social media preference.

2. The system of claim 1, wherein the communication interface transmits, via a network, the product offering to an account holder.

3. The system of claim 1, wherein the data store, communication interface, social signals processor, and product offering processor are integrated into a backend system of a financial institution.

4. The system of claim 1, wherein the application programming interface is associated with a social networking site.

5. The system of claim 1, wherein the application programming interface enables transmission of user account information to identify a user of a social networking site.

6. The system of claim 5, wherein the wherein the data store, communication interface, social signals processor, and product offering processor are integrated into a backend system of a financial institution and the user is an account holder of the financial institution.

7. The system of claim 6, wherein the application programming interface further enables the financial institution to screen scrape the social networking site of the user.

8. The system of claim 5, wherein the application programming interface cooperates with a filter to filter personally identifiable information of the user.

9. The system of claim 1, wherein the product offering processor generates a risk score associated with offering the product offering to a user.

10. The system of claim 1, wherein the determined product offering is based on profile information.

11. A method, comprising:
Storing, in a data store, information about a plurality of product offerings;
receiving at a communication interface via a network, social signals information;
enabling, using a social signals processor coupled to an application programming interface, transmission of the social signals information,
detecting, using the social signals processor, a change in profile information, geo-social information, status information, or social media preference; and
determining, using a product offering processor, a product offering from among the plurality of product offerings based on the detected change in profile information, geo-social information, status information, or social media preference.

12. The method of claim 11, further comprising:
transmitting, via a network using the communication, the product offering to an account holder.

13. The method of claim 11, wherein the data store, communication interface, social signals processor, and product offering processor are integrated into a backend system of a financial institution.

14. The method of claim 11, wherein the application programming interface is associated with a social networking site.

15. The method of claim 11, wherein the application programming interface enables transmission of user account information to identify a user of a social networking site.

16. The method of claim 15, wherein the wherein the data store, communication interface, social signals processor, and product offering processor are integrated into a backend system of a financial institution and the user is an account holder of the financial institution.

17. The method of claim 16, wherein the application programming interface further enables the financial institution to screen scrape the social networking site of the user.

18. The method of claim 15, wherein the application programming interface cooperates with a filter to filter personally identifiable information of the user.

19. The method of claim 11, further comprising:
generating, using the product offering processor, a risk score associated with offering the product offering to a user.

20. The method of claim 11, further comprising;
determining, using the product offering processor, the product offering based on profile information.
